(19) United States
(12) Patent Application Publication
(10) Pub. No.: US 2013/0014962 A1
(43) Pub. Date: Jan. 17, 2013

(54) Fire retardant strip to contain brush fires

(71) Applicant: Rinoud K. Hanna, Rochester, NY (US)

(72) Inventor: Rinoud K. Hanna, Rochester, NY (US)

(21) Appl. No.: 13/135,734

(22) Filed: Jul. 14, 2011

(51) Int. Cl. A62C 8/00

(52) U.S. Cl. 169/48

(57) ABSTRACT

A long strip carrying a fire retardant could be pinned down in the ground to prevent wild fire from advancing in the field. It took a propane torch over 400 seconds to be able to penetrate a strip with a fire retardant at a concentration of 1 g/1 square inch.

### CROSS REFERENCE TO RELATED APPLICATIONS

No priority claim is made but inventor has an issued patent U.S. Ser. No. 7,947,614 Multilayered fire retardant (May 23, 2011) and a published patent application US 2010/0176353 that are related technology.

### STATEMENT REGARDING FEDERALLY SPONSORED RESEARCH

Not Applicable

### NAMES OF PARTIES TO JOINT RESEARCH AGREEMENT

Not Applicable

### BACKGROUND OF THE INVENTION

Patent Application 2010/0176353 described a method of using powdered glass as a fire retardant. Spraying a thin strip of vegetation with a suspended glass powder will prevent the advancement of the fire and cause the fire to die down. This technique is similar to a conventional enameling process. However, it is difficult to spray land and vegetation during a wildfire emergency due to the rapid approach of the fire. For this reason, this process is most effectively carried out with a long plastic or paper strip carrying the fire retardant material. This strip can be pinned down where needed in the field of prevent advancement of the fire.

In order to contain brush and wild fires and stop them from reaching populated areas, the fire fighters use the technique of creating a controlled fire to destroy all combustible material in their path thus denying the wild fires the fuel they need to advance.

However, this method is hard and requires a large number of operators to be effective.

For urban areas a rigid panel containing the fire retardant is suitable for use on the lawn of buildings, for example, or indoors (U.S. Pat. No. 7,047,614 B2) but it would be inadequate to control fires in large open fields.

### DETAILED DESCRIPTION OF THE PREFERRED EMBODIMENTS

The present invention is an alternative to the above technique and consists of fire retardant deposited on a long strip of paper which could be laid down on the ground 2 in anticipation of the incoming fire. The strip could be at least 3-4 feet wide and encased in a thin plastic sheet to protect it from the elements. It is possible that the paper strip could not be wound as a coil in particular when the fire retardant dries it will crack and crumbles.

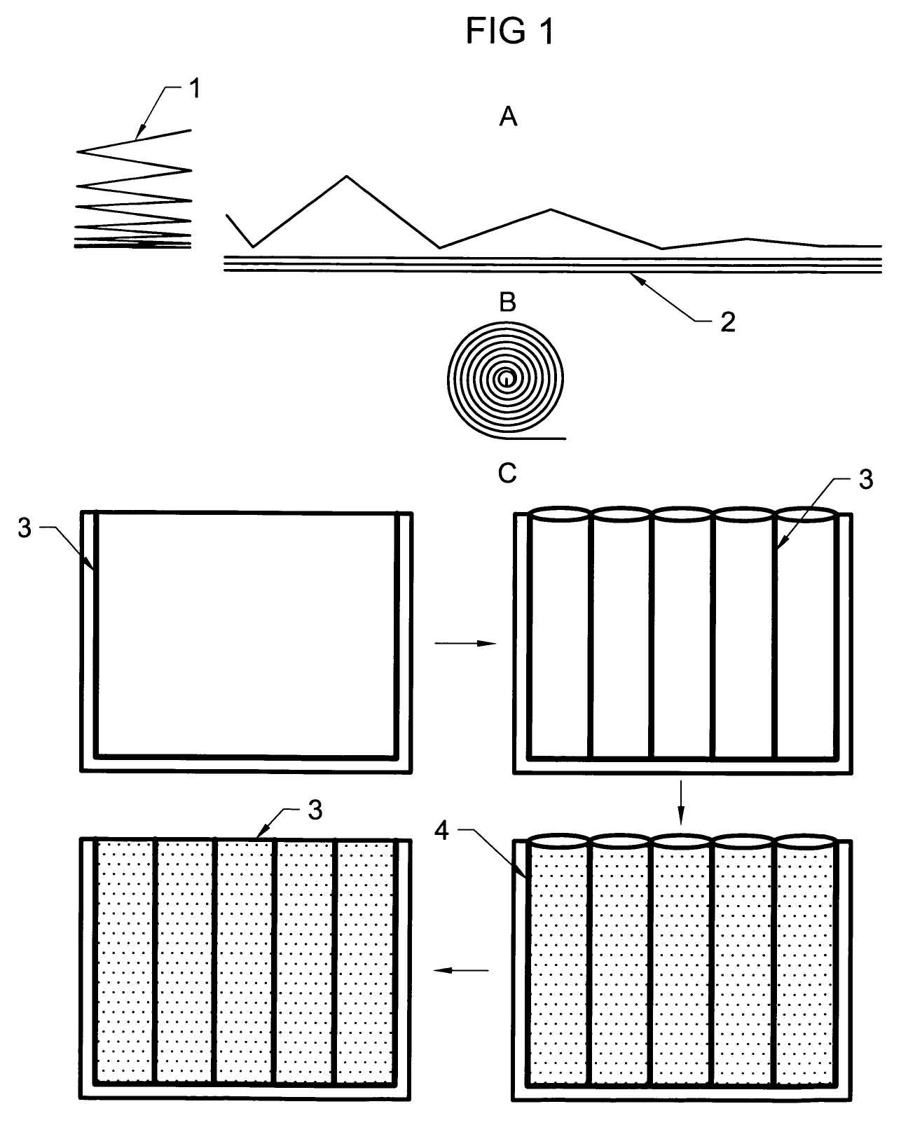

To overcome this problem, the paper strip could be folded as flat sheets 1 on top of each other like an accordion (FIG. 1a).This will avoid the bending or the rolling of the strip.

Another embodiment of this invention is to replace the paper with cloth such as burlap, jute etc. as a substrate to the fire retardant. A 108 gram of fire retardant was deposited on a 6″×18″ piece of burlap and wrapped in thin plastic sheet. Thus the concentration of the fire retardant on the substrate was 1g/square inch. It was possible to roll it without damage to the layer of the deposited fire retardant (FIG. 1b)

Another embodiment of this invention is to put the fire retardant directly in a plastic pocket (FIG. 1c) which is constructed by fusing together two sheets of plastic using electric hot iron. Only 3 sides of the plastic sheets are fused together leaving the fourth one open to form a pocket. The pocket is further divided into segments by drawing fusion lines 3 at one foot interval for example. The fire retardant is then introduced in every segment followed by closing the segments with the electric hot iron.

Some of the advantages of these segments are:

(1) The segments make it very easy to bend and roll the plastic pocket without the movement of the fire retardant from one segment to its neighbor. Sheets of paper 4 could be used inside the segments where the fire retardant could evenly spread on the paper. In addition the paper could add some rigidity to the plastic segments.

(2) Fire retardants in liquid or slurry form could be used in the strip. In such case the segments should be enforced with another layer of plastic to prevent tearing of the segment.

The fire retardant which will be used in the strip is subjected to the Torch Test to determine its efficiency in stopping the fire. Moreover, this test is used to compare several fire retardants among themselves for selection purposes.

The Torch Test

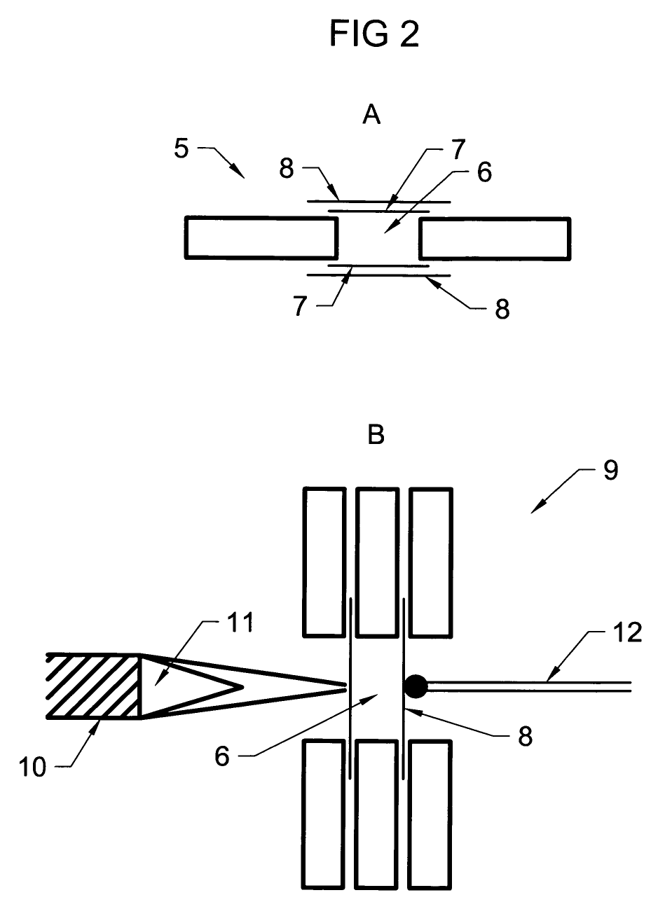

A sample of the fire retardant was prepared as follows: A stainless steel washer 5 with a ¾ inch hole was used (commercially available). A thick piece of paper 7 was glued to the bottom of the washer thus transforming its hole into a well 6 (FIG. 2a). A certain weight of the fire retardant was placed inside the well 6 which was then covered with an upper piece of paper 7. Two pieces of wire mesh 8 were placed on both sides of the well and the whole washer was then placed between two similar stainless steel washers to keep the paper and the wire mesh in place. This will be called “washer assembly” 9.

A Bernzomatic propane torch 10 is used to burn the fire retardant inside the” washer assembly” which has to be in a vertical position. Prior to burning, the Bernzomatic flame is adjusted so that the inner blue cone 11 of the flame (the reducing region) is 1″ in length. This is measured against a ruler placed beyond the flame. The distance between the torch 10 and the “washer assembly” 9 is always the same. This ensures that the burning of the fire retardant is under the same conditions.

On the opposite side of the “washer assembly” a match stick 12 is placed with its head is in contact with the wire screen of the well inside the washer assembly”

With a stop watch the time is measured from the moment the flame of the torch touches the fire retardant sample in the well 6 till the instant when the match stick catches fire on the opposite side of the sample. This measured time is an indicator of the ability of the fire retardant to stop the fire when it is used in the strip. In this present work values of 300 seconds or more were obtained.

It is mentioned above that the strip is laid on the ground 2 of the field to stop the incoming fires from advancing. Holes are made in the margin of the strip and enforced with small metal rings in order to use pins or pegs to pin down the strip to the ground.

If the width of the strip is not enough a second or third strip could be added side by side to the first one. It is also prudent to have a second line of defense few yards away from the first one.

### BRIEF DESCRIPTIONS OF THE DRAWINGS

FIG. 1a: is a view of paper sheets strip
b: is a view of burlap coil strip
c: is a view segmented plastic strip

FIG. 2a: is a cross section of the washer
B: is a cross section of “washer assembly”

1) A continuous fire retardant strip for containing an incoming fire adapted to be pinned to the ground before an incoming fire comprising a fire retardant deposited on heavy paper or cloth comprising one or more independent segments configured to receive and store the fire retardant and wrapped in plastic film.

2. (canceled)

3) The continuous fire retardant strip for containing an incoming fire as recited in claim 1 in the form of a coil or as plurality of stacked flat sheets connected together end to end.

4. (canceled)

5. (canceled)

6) The continuous fire retardant strip for containing an incoming fire as recited in claim 1 further comprising paper disposed inside each segment.

7) The continuous fire retardant strip for containing an incoming fire as recited in claim 1 further comprising a second fire retardant.

8) The continuous fire retardant strip for containing an incoming fire as recited in claim 1 wherein the fire retardant comprises a liquid fire retardant.
